(19) United States
(12) Patent Application Publication
(10) Pub. No.: US 2008/0314918 A1
(43) Pub. Date: Dec. 25, 2008

(54) VENDING APPARATUS FOR DISPENSING MADE-TO-ORDER SALADS

(76) Inventor: Eran Nuriely, Yahud (IL)

Correspondence Address: Eran Nuriely, 3 Hahoresh Street, Kiryat Savionim, Yahud, 56470, IL

(21) Appl. No.: 12/139,104

(22) Filed: Jun. 13, 2008

Related U.S. Application Data
(60) Provisional application No. 60/929,309, filed on Jun. 21, 2007.

(51) Int. Cl. G07F 11/62

(52) U.S. Cl. 221/1; 221/191; 221/155

(57) ABSTRACT

Vending machines for freshly cut and prepared-to-order salads, including containers containing produce products, salad additives and salad dressings. A vending machine can provide a user with a salad of vegetables and/or fruits, that are freshly cut and prepared, and that is made-to-order. Freshly cut and prepared salads preserve their nutritional value, taste and the user selects only items to his liking.

### CROSS REFERENCE TO RELATED APPLICATIONS

This application claims the benefit under 35 USC 119(e) from U.S. provisional application 60/929,306 filed Jun. 21, 2007, the disclosure of which is included herein by reference.

### FIELD OF THE INVENTION

The present invention relates to a vending apparatus for selectively dispensing a salad, and in particular salads containing freshly cut vegetable and/or a fruits.

### BACKGROUND OF THE INVENTION AND PRIOR ART

There are many types of vending machines in the market that provide salads, but vending machines designated for dispensing freshly cut and prepared vegetables, are not yet available.

One type of vending machines for dispensing salads provides salads that are prepared ahead of time, whereas the ingredients are also selected and cut ahead of time. U.S. Pat. No. 5,544,572, given to Davis, provides a refrigerated cabinet including a compartment for salad and another compartment for salad dressing, rendering both the salad and salad dressing easily accessible to the user, and dispensing means for the salad and salad dressing. Typically, salads that are prepared ahead of time lose many of the nutritional ingredients, such as vitamins, which exist when the salad is freshly prepared. Salads that are prepared ahead of time, also loose the contrast in taste of the various ingredients, as time passes from the time the salad was prepared. Salads that are prepared ahead of time may include items that a particular user does not like or want, and miss items that a particular user does want.

Another type of vending machines that provides salads, provide salads that are cut ahead of time, whereas the ingredients are selected but the user of the vending machine. U.S. patent application 20040238555, by Parks, suggested a vending machine that automatically assembles and delivers a made-to-order food item such as a submarine sandwich, salad, taco, or sandwich wrap in response to a customer order. The machine includes a conveyer that produces relative motion between a food item and ingredient dispensing stations that dispense customer-selected ingredients, including condiments, dressings, seasonings, sliced meats and cheeses, vegetables, and soft sandwich spreads. The machine includes pre-cut diced vegetables but not freshly cut vegetables. Typically, salads containing items that are cut ahead of time lose many nutritional ingredients, such as vitamins, which exist when the salad is freshly prepared. Salads items that are cut ahead of time also become bland over time.

Thus, there is a need for and it would be advantageous to have a vending machine that can provide a user with a salad which contains a mixture of vegetables and/or fruits, that are freshly cut and prepared, and that is made-to-order.

### SUMMARY OF THE INVENTION

The term “produce” is used herein to refer to vegetable, fruits, vegetable pieces and/or fruits pieces. The vegetables and/or fruits can be peeled or unpeeled.

The terms “cut”, “grind”, “blend” and “crush” are used herein interchangeably.

The term “salad additives” is used herein to refer to various ingredients that can be added to a produce salad, for example, salt, pepper, raisins, sunflower seeds, sesame seeds, croutons, hard boiled eggs cheese, tuna, corn, etc.

The term “cutting mechanism” is used herein to refer to a mechanism for cutting, grinding and/or crushing produce items or produce pieces into smaller pieces or particles.

It is the intention of the present invention to provide a vending machine that can provide a user with a salad which contains a mixture of vegetables and/or fruits, that are freshly cut and prepared, and that is made-to-order. Freshly cut and prepared salads preserve their nutritional value, taste and the user selects only items to his liking. The user can also select the salad dressing to his liking.

According to the teachings of an embodiment of the present invention there is provided a vending apparatus for dispensing freshly cut and prepared made-to-order salads, the apparatus including:
a) an enclosed housing;
b) a mechanism for dispensing a dish for serving the salad. The dish is selected from the group including a plate, a bowl, a cup;
c) at least one produce container, which can hold one or more produce items or produce pieces. The produce can be any kind of vegetable and/or fruit. The produce container may hold a mixture of produce items and/or produce pieces;
d) at least one mechanism for cutting, grinding and/or crushing the produce or produce pieces. The cutting mechanism is selected from the group including a blender, a mixer, a grinder, and is referred to as a cutting mechanism. Each produce container may be coupled with a cutting mechanism;
e) optionally, one or more salad additive ingredients container;
f) optionally, one or more liquid container, which holds a salad dressing;
g) a mechanism for transferring the produce or produce pieces from a produce container to the at least one cutting mechanism, such as a door that opens up for a preset period of time. The door can be coupled with a pipe that leads the produce from the lower end of the produce container to upper end of the cutting mechanism;
h) a mechanism for transferring the produce pieces or particles from the at least one cutting mechanism to the dispensed dish, such as a pipe;
i) a compartment where the dispensed dish with the prepared salad can picked up by the user; and
j) a controller for automatically initiate the salad preparation in response to a customer's selection.

The optional, at least one liquid container liquid container, contains a salad dressing selected from the group of dressings including 1000 islands, French, Vinaigrette, yogurt, garlic, blue cheese, Rockford, Caesar, orange juice or any other kind of salad dressing. Alternatively, salad dressings can be supplied to user in commonly used enclosed packages.

The optional, one or more salad additive ingredients container, contains items selected from the group of ingredients including salt, pepper, raisins, sunflower seeds, sesame seeds, croutons or any other kind of salad additives.

In embodiments of the present invention, at least a portion of the vending apparatus housing is refrigerated. All of the produce products are preferably kept refrigerated.

According to the teachings of embodiments of the present invention there is provided a method for dispensing freshly cut and prepared salads from a vending apparatus. A salad selecting procedure precedes the salad production.

In a salad selecting procedure, according to the teachings of embodiments of the present invention, available produce items menu is displayed to the user, and the user selects produce items to his liking. If the user selects a produce item that is not available, a message is displayed to the user, who in turn can make a new selection. After the selection is completed the cost is displayed to the user, who can make the payment. The vending apparatus accepts the payment and initiates the salad production. The initiation includes, but not limited to, identifying and selecting the containers containing selected produce, and selecting at least one cutting mechanism to be used. Optionally, the user can select the size of the produce pieces into which produce items are to be cut.

Once the salad selecting procedure is complete, the automatic process for producing the selected salad is ready to commence, according to the teachings of embodiments of the present invention. A dish is dispensed and place in a collecting location at the cutting area. Selected produce or produce pieces are transferred to at least one cutting mechanism. The transferred produce and or produce pieces are cut into pieces, which are transferred to the dispensed dish. Selected additives are also transferred to the dispensed dish. The salad dish can now be transferred by the user to the dressing area. Selected dressing is added to the salad. The freshly cut and prepared salad is ready. It should be noted that the salad dressing area and additive area can be joint or separated. It should also be noted that salad dressings and/or salad additives can be alternatively supplied to user in commonly used enclosed packages.

In embodiments of the present invention, a liquid container or a liquid compartment contains water or other cleaning liquids to clean at least one cutting mechanism. A blender may also include mechanism to remove and collect waist, such as peelings, seeds and other solid waist and pulp, from the cutting mechanism.

In embodiments of the present invention, the mechanism for transferring the produce or produce pieces from the produce container or produce compartment to the cutting mechanism or to the dispensed dish can be a picker, such as a moving arm including a grabbing mechanism.

In embodiments of the present invention, the mechanism for transferring the produce or produce pieces from the produce container or produce compartment to the cutting mechanism can be a pushing mechanism, wherein the pushing mechanism pushes the produce upwards by some pushing mechanism, such as a piston, into the cutting mechanism or the dispensed dish.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 is a schematic side perspective view of a vending apparatus for dispensing freshly cut and prepared salads, according to embodiments of the present invention;

FIG. 2 is a schematic flow diagram showing the successive steps taken, from purchasing till the delivery of a salad, performed on a vending apparatus as shown in FIG. 1, according to embodiments of the present invention; and

FIG. 3 is a schematic side perspective view of a vending apparatus for dispensing salads, according to embodiments of the present invention, having a picker.

### DETAILED DESCRIPTION OF EMBODIMENTS OF THE INVENTION

The present invention provides a vending machine that enables a user to obtain a salad which contains a mixture of vegetables and/or fruits selected by the use, and which are freshly cut and prepared. Freshly cut and prepared salads preserve their nutritional value, taste and the user selects only items to his liking. The user can also select the salad dressing to his liking.

It should be noted that in the preferred embodiment of the present invention salads are produced from fresh produce products, but the present invention is not limited to fresh produce products and preserved produce products can also be used and are within the scope of the present invention.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

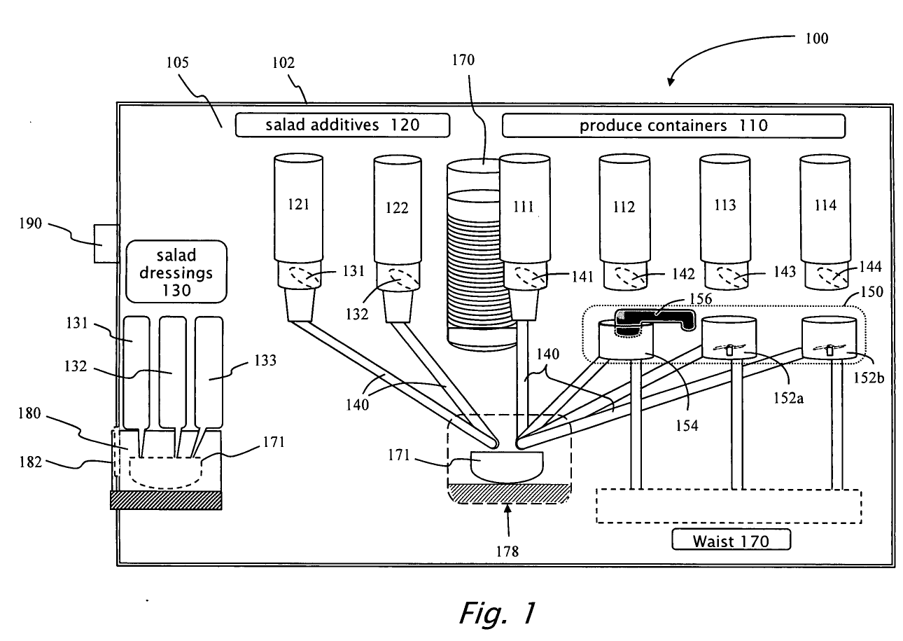

A first embodiment of the invention will now be described with reference to FIG. 1 which is a schematic side perspective view of a vending apparatus 100 for dispensing freshly cut and prepared salads, according to embodiments of the present invention.

Vending apparatus 100 includes: a housing 102 which contains:
a) a housing 102;
b) a compartment 170 for holding dispensable plates 171;
c) at least one container 110 which holds a fresh produce product or produce pieces. Relevant produce products will be peeled off before filling the containers. The produce can be any kind of vegetable and/or fruit. Produce container 110 may hold a mixture of produce items and/or produce pieces. The number of containers 110 is limited only by the space in housing 102;
d) at least one mechanism 150 for cutting, grinding and/or crushing the selected produce product or produce product pieces. Cutting mechanism 150 is selected from the group including a blender 152, a mixer and/or a grinder 154 with a pressing mechanism 156. Each produce container 110 may be coupled with a cutting mechanism 150, and alternatively a cutting mechanism 150 can serve two or more produce containers 110;
e) optionally, one or more containers 120 may hold at least one salad additive ingredient including dry additives such as salt, pepper, raisins, sunflower seeds, sesame seeds, croutons or any other kind of salad. A container 120 may hold wet or semi-wet salad additive ingredient such as cheese, tuna, eggs, corn, etc;
f) mechanism 140 for transferring the produce and/or produce pieces from containers 110 and 120 to cutting mechanism 150 or directly into plate 171. Transfer mechanisms 140 can be a door that opens up for a preset period of time. The door can be coupled with a pipe that leads the produce from the lower end of produce container 110 to upper end of a cutting mechanism 150. Transfer mechanisms 140 can be a pipe that leads the produce or an additive from container 110, 120 or 133 directly into plate 171;
g) optionally, one or more containers 120 can hold water for cleaning clean cutting mechanisms 150 and/or transfer mechanisms 140;
h) optionally, one or more liquid container 130, which holds a salad dressing.
i) optionally, a mechanism 170 for collecting waist from a cutting mechanisms 150 such as peelings, seeds and other solid waist and pulp;
j) a dispensing compartment 178 for the customer to pick plate 171 with the salad he selected, when ready;
k) optionally, a compartment 180 for the customer to pickup one or more salad dressing packages, or to add salad dressing to the ready, freshly cut and prepared salad; and
l) a control panel 190 for the customer to operate the apparatus, which can be activated from the outside, normally by a customer who pays for the salad by coins, credit card, debit card, prepaid card, bank card, or by paper money or other cash.

In embodiments of the present invention, vending apparatus 100 can also includes a mechanism for conveying plate 171 from one location to another, for example, from station 178 to station 180. The mechanism can be a conveying belt or any other mechanism.

Internal space 105 of vending apparatus 100 is at least partially refrigerated to preserve the freshness of the various produce products.

The front and other portions of housing 102 walls can optionally be made of clear material, such as glass, to allow the customer and passers-by to watch the salad being prepared.

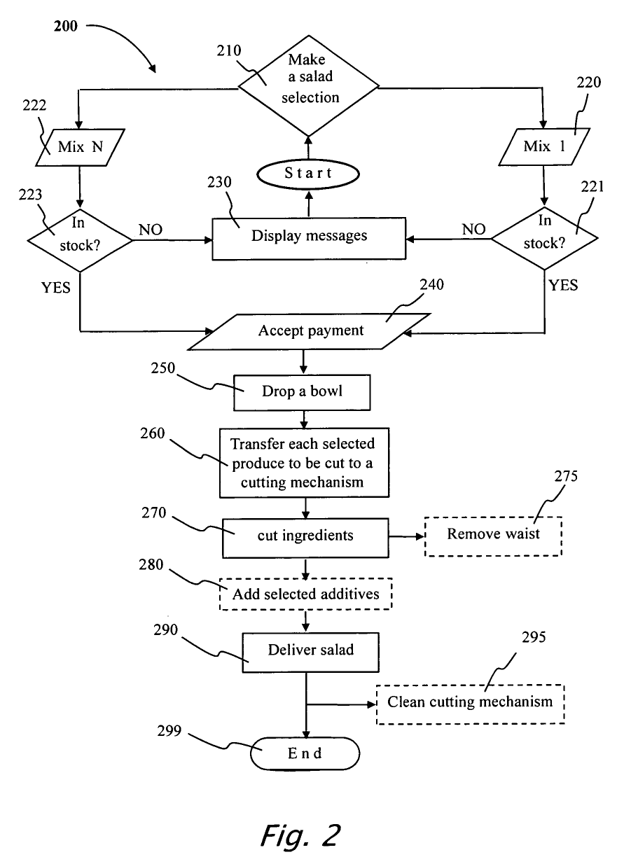

The process of operating a vending apparatus 100 for dispensing freshly cut and made-to-order salads will now be described, with reference to FIG. 2. FIG. 2 is a schematic flow diagram 200 showing the successive steps taken, from purchasing till the delivery of a salad, performed on vending apparatus 100 as shown in FIG. 1, according to embodiments of the present invention.

To operate vending apparatus 100, available salad ingredients are displayed on a massage screen in payment control box 190, in steps 220 and 222. A user starts process 200 of making a salad with ingredients of his selection, when the user goes through the preprocess steps of making the salad selection. The preprocess steps are finalized when the user makes a payment in step 240. Process 200 then proceeds automatically to produce the selected salad. Process 200 includes the following steps:

### Preprocess Steps:

Step 210—The user selects items from available salad produce products and optionally other ingredients and salad dressing, via payment control box 190. Optionally the user can also select the size of pieces into which the produce products are to be cut. All options are on a massage screen in payment control box 190, in steps 220 and 222.
Steps 221/223—If a user selection is not in stock, an appropriate message is displayed in step 230 and the user can return to step 210 to make a new selection.
Step 240—when all salad ingredients are established, the user makes the payment via control box 190 or pushes a start button or any other mechanism a like.

### Process Steps:

Once payment is accepted by vending apparatus 100, an automatic cycle of producing the salad ordered, begins.
Step 250—a single plate 171 drops onto a collecting location 178 where the salad is prepared.
Step 260—each produce-product/produce-pieces selected in step 210 is transferred to a next location. Produce products that need not to be processed, are transferred directly to plate 171. For example cherry tomatoes maybe serve whole and lettuce maybe pre-washed and cut.
   Produce products that need to be cut are transferred to cutting mechanisms 152. Produce products that need to be grinded, for example carrots, are transferred to cutting mechanisms 154, and so on and so forth, each produce product needs to be cut is transferred to the appropriate cutting mechanism 150.
   Each container 110 includes an opening mechanism (131, 132, 141, 142, 143 and 144) which operates to transfer the selected produce from produce container 110 into either plate 171 or to the appropriate cutting mechanism 150. For example, the opening mechanism may include a door that opens and the produce drops into a cutting mechanism 150 just below container 110, or into a transferring pipe 140.
Step 270—cutting mechanism 150 contains at least one produce. The cutting mechanism 150 cuts the produce into small pieces.
Step 275—cutting mechanism 150 optionally contains a waist removal mechanism operatively attached to a waist disposal 170, to remove any produce waist from each cutting mechanism 150, as needed.
Step 280—optionally, selective salad additives are added to the salad being prepared. Containers 120 holding ingredients selected by the user, open up for a pre-selected period of time and each selected ingredient is transferred to plate 171.
Step 290—plate 171 containing the salad being prepared is picked up by the user from dispensing compartment 178.
   Optionally, optionally, the customer can pickup one or more salad dressing packages from compartment 180, or to add salad dressing from container 130 to the ready, freshly cut and prepared salad
   The client may need to open a door in order to reach into compartments 178 and/or180 to reach into the compartment.
Step 295—cutting mechanism 150 is optionally cleaned by some cleaning mechanism, as needed. The cleaning mechanism may include a container 120 which is filled with cleaning liquid such as water, which washes one or more cutting mechanism 150.
Step 299—the vending apparatus 100 enters a wait state, ready for the next freshly made salad producing cycle.

In some embodiments of the present invention, the salad dressing is added to the salad being prepared at location 178. In other embodiments of the present invention, the salad dressing and the additives are added to the salad being prepared at location 180. In still other embodiments of the present invention, the produce products are added to the salad being prepared at one location, the salad dressing is added to the salad being prepared at another location and the additives are added to the salad being prepared at yet another location.

In embodiments of the present invention, a container 110 may contain a mixture of produce products, for example, a mixture various types of leaves such as lettuce, rocket, and cabbage and so on and so forth.

In embodiments of the present invention, a container 120 may contain a mixture of ingredients, for example various types of grains such as sunflower seeds, sesame seeds, etc.

In embodiments of the present invention, compartments 178 and 180 are the same compartment.

### EXAMPLE

A client selects a salad containing lettuce, cucumbers, tomatoes, tuna and spicy dressing. A plate 171 is dropped at location 178. Container 114 contains tomatoes, container 113 contains cucumbers and container 111 contains pre-washed and cut lettuce. Opening mechanisms 141, 143 and 144 of containers 111, 113 and 114 respectively, open-up for a preset period of time. Tomatoes are transferred to cutting mechanism 152b, cucumbers are transferred to mechanism 152a, and the pre-washed and cut lettuces are transferred directly to plate 171. Cutting mechanisms 152 are operated to cut the tomatoes and cucumbers. After a preset period of time the cut tomatoes and cucumbers are transferred from cutting mechanisms 152 to plate 171 by a transfer mechanism 140. Container 122 contains tuna chunks. Opening mechanisms 132 of containers 122 opens-up for a preset period of time and a measured quantity of tuna chunks are transferred directly to plate 171. Plate 171 is transferred by the user to compartment 180, where Container 131 contains spicy salad dressing. Container 131 is operated to transfer a measured quantity of spicy salad dressing to plate 171. The freshly cut, made-to-order tuna salad is now ready inside plate 171.

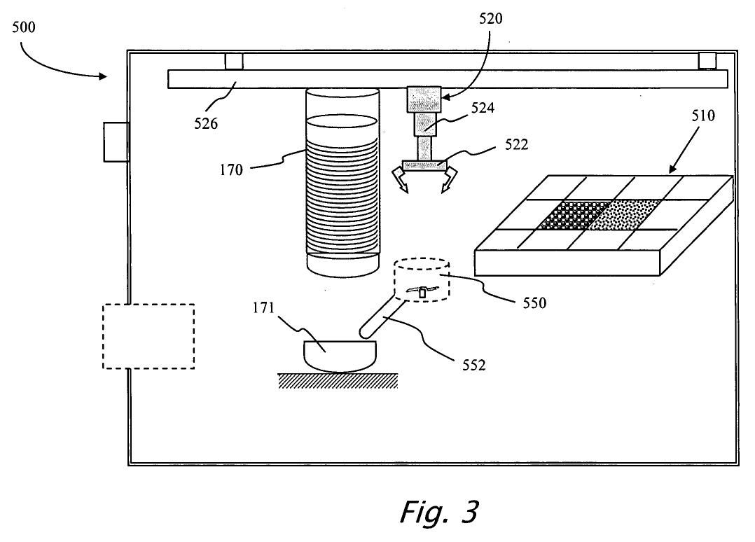

Reference is now made to FIG. 3, which are schematic side perspective views of vending apparatus 500 for dispensing salads, according to embodiments of the present invention, having a picker 520. In vending apparatus 500, the ingredients are not drop into plate 171 but rather be picked by a picker 520, such as an arm 524 with a grabbing mechanism 522, from selected compartments 510 into the plate 171 or optional, into a compartment of a cutting mechanism 550. Compartments 510 may contain produce products, cut and ready to serve produce products, salad additives and/or salad dressings. Picker 520 includes a moving mechanism 526. Cutting mechanism 550 includes a mechanism 522 or 524 or any other mechanism to transfer the salad ingredients the compartment of a cutting mechanism 550 to plate 171.

In embodiments of the present invention, a vending apparatus for dispensing freshly cut and prepared salads includes a picker as in vending apparatus 500, mounted on one or more carousels.

In embodiments of the present invention, a vending apparatus for dispensing freshly cut and prepared salads includes a picker as in vending apparatus 500, containers 110, 120 and/or 130 as in vending apparatus 100, mounted on one or more carousels.

The invention being thus described in terms of the embodiments and examples, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A vending apparatus for dispensing freshly cut and prepared-to-order salads, the vending apparatus comprising:
a) an enclosed housing;
b) a mechanism for dispensing a dish for serving the salad;
c) at least one produce container, wherein said container holds one or more produce items;
d) at least one cutting mechanism for cutting said produce items;
e) a transfer mechanism for transferring said produce items from said at least one produce container to said at least one cutting mechanism;
f) a transfer mechanism for transferring the produce pieces or particles from said at least one cutting mechanism to said dispensed dish;
g) a pickup compartment where the dispensed plate with the prepared salad can picked up by the user; and
h) a controller for automatically initiate the salad preparation in response to a customer's selection.

2. The vending apparatus of claim 1, wherein said produce items are selected from the group consisting of: whole vegetables, whole fruits, peeled vegetables, peeled fruits, vegetable pieces, fruit pieces.

3. The vending apparatus of claim 1, wherein said cutting mechanism is selected from the group including: a blender, a mixer, a grinder.

4. The vending apparatus of claim 1, further comprising one or more salad additive ingredients container.

5. The vending apparatus of claim 1, further comprising one or more liquid containers, which hold salad dressing.

6. The vending apparatus of claim 1, further comprising a mechanism for moving said dispensed dish.

7. The vending apparatus of claim 6, wherein said mechanism for moving the cup is a moving belt.

8. The vending apparatus of claim 1, wherein said cutting mechanism includes a waist removal mechanism.

9. The vending apparatus of claim 1, wherein each of said produce container is coupled with one of said cutting mechanism.

10. The vending apparatus of claim 1, wherein said transfer mechanism for transferring said produce items from said at least one produce container to said at least one cutting mechanism is a controlled door.

11. The vending apparatus of claim 1, wherein said transfer mechanism for transferring said produce items from said at least one produce container to said at least one cutting mechanism is a controlled door coupled with a pipe.

12. The vending apparatus of claim 1, wherein said transfer mechanism for transferring said produce items from said at least one produce container to said at least one cutting mechanism is a picker.

13. The vending apparatus of claim 1, wherein said transfer mechanism for transferring the produce pieces or particles from said at least one cutting mechanism to said dispensed dish is a pipe.

14. The vending apparatus of claim 1, wherein at least a portion of said housing is refrigerated.

15. The vending apparatus of claim 1, wherein at least a portion of said housing is made of clear material to allow the customer and passers-by to watch the salad being prepared.

16. An automatic method for preparing freshly cut and prepared-to-order salads, the method comprises the steps of:
a) providing a vending apparatus having:
i. an enclosed housing;
ii. a mechanism for dispensing a dish for serving the salad;
iii. at least one produce container, wherein said container holds one or more produce items;
iv. at least one cutting mechanism for cutting said produce items;
v. a transfer mechanism for transferring said produce items from said at least one produce container to said at least one cutting mechanism;
vi. a transfer mechanism for transferring the produce pieces or particles from said at least one cutting mechanism to said dispensed dish;
vii. a pickup compartment where the dispensed plate with the prepared salad can picked up by the user; and
viii. a controller for automatically initiate the salad preparation in response to a customer's selection;
b) selecting one or more items from available produce items using said controller;
c) dispensing a plate onto a collecting location where the salad is prepared;
d) transferring said selected produce items to be served as a whole to said dish;
e) transferring said selected produce items to be cut to said cutting mechanism;
f) activating said cutting mechanism to a preset time period;
g) transferring said cut produce items to said dish; and
h) transferring said dish with the salad to said pickup compartment.

17. The method of claim 16, wherein said cutting mechanism includes a waist removal mechanism, and wherein said controller removes any waist from said cutting mechanism to a waist disposal.

18. The method of claim 16 further comprises a step of selecting and adding salad additives.

19. The method of claim 16 further comprises a step of selecting and adding salad dressing.
